(19) United States
(12) Patent Application Publication
(10) Pub. No.: US 2026/0107120 A1
(43) Pub. Date: Apr. 16, 2026

(54) APPARATUS AND METHOD FOR RESTORING NEAR FIELD COMMUNICATION SIGNALS USING ARTIFICIAL INTELLIGENCE TECHNOLOGY

(71) Applicant: Korea University Research and Business Foundation, Seoul (KR)

(72) Inventors: Hwang-Nam KIM, Seoul (KR); Hyeon-Tae JOO, Seoul (KR); Sang-Min LEE, Seoul (KR)

(21) Appl. No.: 19/354,738

(22) Filed: Oct. 9, 2025

(30) Foreign Application Priority Data
Oct. 16, 2024 (KR) 10-2024-0141661

(51) Int. Cl. H04W 4/80; G06N 3/0475; G06N 3/094; H04B 5/70

(52) U.S. Cl. CPC H04W 4/80; G06N 3/0475; G06N 3/094; H04B 5/70

(57) ABSTRACT

The present disclosure relates to a Near Field Communication (NFC) signal restoration apparatus comprising: preprocessing circuitry for receiving and preprocessing an original NFC signal transmitted from an NFC signal transmission device, and detecting a noise NFC signal whose signal quality is lowered below signal quality required for NFC communication in a preprocessing process; restoration circuitry for inputting the noise NFC signal to a pre-trained generative model, and restoring the noise NFC signal to a clean NFC signal of a same signal quality as the original NFC signal by minimizing frequency distortion while maintaining temporal continuity of the noise signal; and data processing circuitry for detecting a clock signal by analyzing the temporal characteristics of the restored clean NFC signal, and generating data used in an application to which the NFC communication is applied based on the restored clean NFC signal and the detected clock signal.

### CROSS REFERENCE TO RELATED APPLICATIONS

This application claims priority to Korean Patent Application No. 10-2024-0141661, filed on Oct. 16, 2024, in the Korean Intellectual Property Office, which is incorporated by reference herein in its entirety.

### TECHNICAL FIELD

The present disclosure relates to an apparatus and a method for restoring Near Field Communication (NFC) signals, and more particularly, to an apparatus and a method for restoring a NFC signal whose quality is deteriorated due to signal attenuation, noise, and other environmental factors by using an artificial intelligence model.

### BACKGROUND

NFC technology is a wireless communication technology is a set of short-range wireless technology between two electronic devices. In an embodiment, NFC technology mainly operates in the 13.56 megahertz (MHz) frequency band, and is generally used in mobile devices such as smartphones or electronic payment systems. The NFC generates an alternating current (AC) based on electromagnetic induction to enable stable communication only at a very short distance (within about 1 centimeters (cm) or less). That is, the NFC wireless technology is based on inductive coupling between two electromagnetic coils present on an NFC enabled device. In an embodiment, the NFC wireless technology operates only when the transmitter and the receiver are physically close to each other allowing a stable magnetic field to be formed, and data transmission is performed through this. Due to these characteristics, NFC can be utilized in various fields such as mobile payment, transportation card, access control, and data exchange.

However, while using NFC, if the distance between the devices is increased, the signal is rapidly weakened and a communication failure situation may occur since NFC best operates on short communication distance within 1 cm. In an embodiment, as the communication distance is increased, the signal attenuation becomes severe, and the signal quality is deteriorated due to noise or interference generated in the surrounding environment. In addition, due to the short communication distance, NFC is used only in some limited applications such as payment systems and access control systems. That is, as it is essential to contact a real tag or device, there are limitations in terms of wide usability in the fields of production and industrial use.

Therefore, there is a need for research on ways to overcome these limitations of NFC technology and enable reliable communication in a wider range.

### SUMMARY

The present disclosure has been devised to solve the above technical problems, and an object of the present disclosure is to provide an apparatus and a method for restoring NFC signals using an artificial intelligence model.

According to an aspect of the present disclosure, there is provided an apparatus for restoring an NFC signal, the apparatus including: preprocessing circuitry configured to receive and preprocess an original NFC signal transmitted from an NFC signal transmitting apparatus, and detect a noise NFC signal whose signal quality is reduced below a signal quality required for NFC communication in a preprocessing process; restoration circuitry configured to input the noise NFC signal to a pre-trained generative model, and recover a clean NFC signal of the same signal quality as the original NFC signal by minimizing frequency distortion while maintaining temporal continuity of the noise NFC signal; and data processing circuitry configured to detect a clock signal by analyzing a temporal characteristic of the recovered clean NFC signal, and generate data used in an application to which the NFC communication is applied based on the recovered clean NFC signal and the detected clock signal.

According to an aspect of the present disclosure, there is provided a method of recovering an NFC signal, the method including: receiving, by preprocessing circuitry, an original NFC signal transmitted from an NFC signal transmission device and preprocessing the received original NFC signal, and detecting a noise NFC signal in which signal quality is lowered to a signal quality required for communication in a preprocessing process; inputting, by restoration circuitry, the noise NFC signal to a generative model provided in advance, and restoring the noise NFC signal into a clean NFC signal having the same signal quality as the original NFC signal by minimizing frequency distortion while maintaining temporal continuity of the noise signal; and detecting, by a data processing circuitry, a clock signal by analyzing temporal characteristics of the recovered clean NFC signal, and generating data used in an application to which the NFC communication is applied based on the recovered clean NFC signal and the detected clock signal.

According to one aspect of the present disclosure described above, by providing an apparatus and a method for restoring NFC signals using an artificial intelligence model, an NFC communication distance that is only available in the existing 1 cm or so is greatly expanded, thereby enabling stable communication within a wider range.

In an embodiment, by restoring the attenuated signal through the artificial intelligence model considering the time series characteristics, it is possible to maintain a signal quality similar to that of the original NFC signal even at a long distance, and through this, the NFC technology, which was limited only to the existing payment system, may be applied to various fields such as smart home, Internet of Things (IoT), vehicle communication, and industrial systems. That is, the NFC technology can be used at a wider range.

In an embodiment, it is possible to enhance the security of NFC communication by minimizing data loss and errors that may occur in a communication environment through NFC signal restoration.

### BRIEF DESCRIPTION OF THE DRAWINGS

FIG. 1 is a diagram schematically illustrating an apparatus for restoring NFC signals according to an embodiment of the present disclosure,

FIG. 2 is a diagram illustrating a detailed block of the apparatus for restoring NFC signals of FIG. 1,

FIG. 3 is a diagram for describing a generative model applied to the restoration generator of FIG. 2, and

FIG. 4 is a flowchart illustrating an NFC signal reconstructing operation of the apparatus for restoring NFC signals according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

A detailed description of the present disclosure, which will be described later, refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein may be implemented in other embodiments without departing from the spirit and scope of the present disclosure with respect to one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

In the entire specification, when a part is described as being “connected” (attached, contacted, coupled) to another part, it includes not only being “directly connected” but also “indirectly connected” through another component. Also, when a part is described as “including” a component, it means that it may further include other components, unless otherwise specified.

The terminology used in this specification is intended only to describe specific embodiments and is not intended to limit the present invention. The singular expressions may include plural expressions unless the context clearly indicates otherwise. In this specification, terms such as “comprise” or “have” are intended to indicate the presence of the stated features, numbers, steps, operations, elements, components, or combinations thereof, and are not intended to exclude the possibility of the presence or addition of one or more other features, numbers, steps, operations, components, or combinations thereof.

In this specification, the term “module” includes a unit configured in hardware, software, or firmware, and may be used interchangeably with terms such as logic, logic block, component, circuit, or circuitry. A module may be an integrated component or the smallest unit performing one or more functions, or a part thereof. For example, the module may be implemented as an application-specific integrated circuit (ASIC).

Hereinafter, exemplary embodiments of the present disclosure will be described in more detail with reference to the drawings.

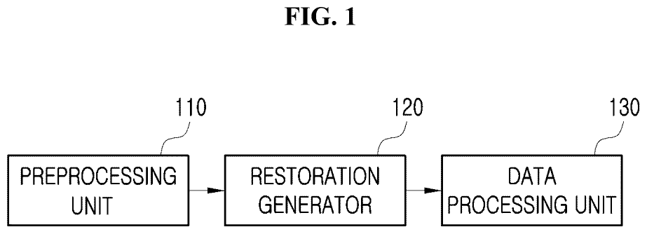

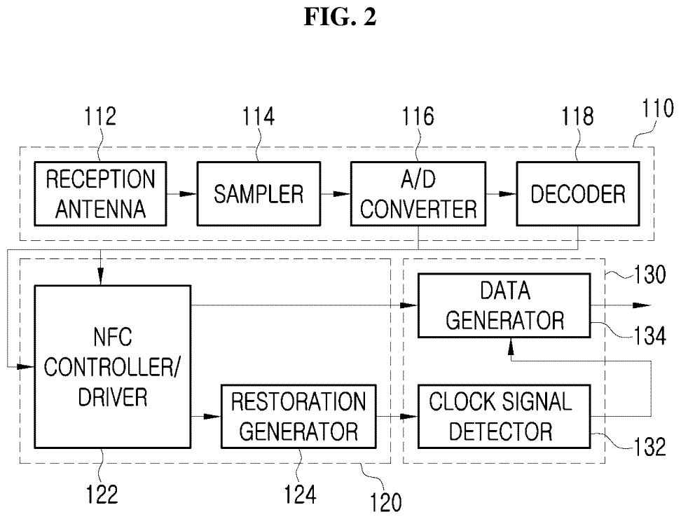

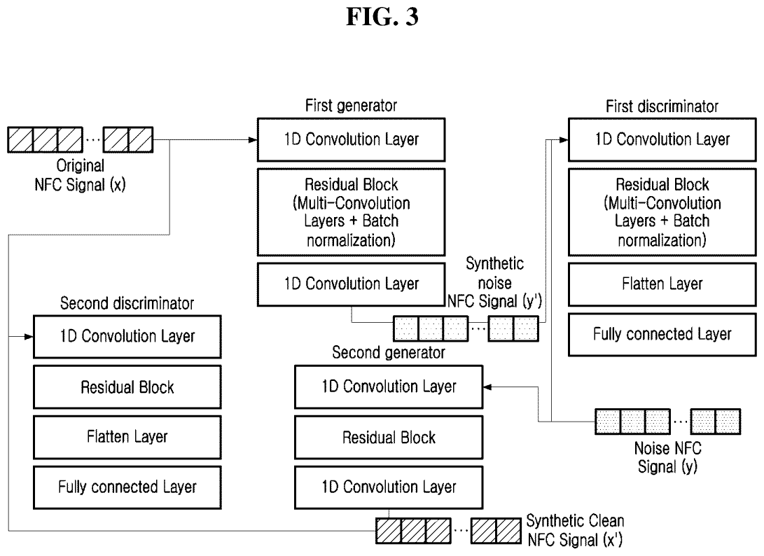

FIG. 1 is a diagram schematically illustrating an apparatus for restoring NFC signals according to an embodiment of the present disclosure, FIG. 2 is a diagram illustrating a detailed block of the apparatus for restoring NFC signals of FIG. 1, and FIG. 3 is a diagram for describing a generative model applied to the restoration unit of FIG. 2.

The apparatus for restoring NFC signals shown in FIG. 1 includes a preprocessing unit 110 (e.g., preprocessing circuitry), a restoration unit 120 (e.g., restoration circuitry), and a data processing unit 130 (e.g., data processing circuitry), and detailed blocks of each component are shown in FIG. 2. That is, the preprocessing unit 110 includes a reception antenna 112, a sampler 114, an Analog to Digital (A/D) converter 116, and a decoder 118, the restoration unit 120 includes an NFC controller/driver 122 and a restoration generator 124, and the data processing unit 130 includes a clock signal detector 132 and a data generator 134.

The preprocessing unit 110 receives and preprocesses an original NFC signal transmitted from the NFC signal transmission device through the reception antenna 112, and detects a noise NFC signal whose signal quality is lowered below the signal quality required for NFC communication in the preprocessing process.

The original NFC signal received through the reception antenna 112 may be properly received only at a very short distance as an analog signal. For example, when the distance between the NFC signal transmission device and the apparatus for restoring NFC signals receiving the original NFC signal becomes far or an obstacle exists, the original NFC signal may be attenuated or noise is included. In such embodiment, the signal quality may be lowered to a signal quality that is less than what is required for NFC communication.

In more detail, referring to FIG. 2, the sampler 114 samples the original NFC signal, which is an analog signal, to convert the original NFC signal into a digital signal. In such embodiments, the A/D converter 116 converts the sampled original NFC signal into a digital signal. In this case, the A/D converter 116 detects a signal in which distortion or loss occurs in the process of converting an analog signal into a digital signal as a noise NFC signal and transmits the noise NFC signal to the restoration generator 124 through the NFC controller/driver 122.

The decoder 118 decodes the original NFC signal converted into the digital signal through the A/D converter 116 based on a predetermined modulation scheme—e.g., based on an Amplitude Shift Keying (ASK) modulation, Frequency Shift Keying (FSK) modulation, Phase Shift Keying (PSK) modulation, or the like. In this case, the decoder 118 detects a signal that has failed to be decoded as a noise NFC signal and transmits the detected signal to the restoration generator 124 through the NFC controller/driver 122, and transmits a signal that has succeeded in decoding to the data generator 134 through the NFC controller/driver 122.

The restoration generator 124 receiving the noise NFC signal from the A/D converter 116 and the decoder 118 inputs the noise NFC signal to a generative model that is an artificial intelligence model that independently processes the original NFC signal and the noise NFC signal in individual domains. In such embodiments, the generative model restores the noise NFC signal to a clean NFC signal having the same signal quality as the original NFC signal by minimizing frequency distortion while maintaining the temporal continuity of the noise signal. In an embodiment of the present disclosure, an NFC restoration apparatus for restoring the noise NFC signal to a clean NFC signal using a Generative Adversarial Network (cycleGAN) as an example of a generative model will be described. However, the apparatus for restoring NFC signals according to the present disclosure may restore the noise NFC signal to the clean NFC signal using other generative models such as a transformer, a variational autoencoder, and the like.

Referring to FIG. 3 in more detail, the cycleGAN used in the restoration generator 124 is a generative model that converts the original NFC signal ‘x’ and the noise NFC signal ‘y’ by considering them as different domains, and includes a first generator and a first discriminator related to conversion of the original NFC signal, and a second generator and a second discriminator related to conversion of the noise NFC signal.

In addition, the cycleGAN is provided through the steps of generating a fake noise NFC signal y′ by artificially reducing the signal quality of the original NFC signal x by inputting the original NFC signal x to a first generator. In such embodiments, the cycleGAN is further to cause training of the first discriminator to compare and distinguish the noise signal y and the fake noise NFC signal y′. In an embodiment, the cycleGAN is further to cause generating a fake clean NFC signal x′ by minimizing frequency distortion while maintaining the temporal continuity of the noise NFC signal y by inputting the noise NFC signal y to a second generator and training the second discriminator to compare and distinguish the fake clean NFC signal x′ and the original NFC signal x.

Here, each of the first and second generators includes an initial one-dimensional data (1D) convolution layer, a residual block, and a last 1D convolution layer.

Since the NFC signal has a time series characteristic, the generator learns a temporal pattern using a 1D convolutional layer. In addition, a convolutional layer with a large kernel size captures long-distance dependence within the signal, since long-distance dependence plays an important role in the time domain NFC signal.

In addition, the generator uses the residual block and the 1D convolutional layer together to reflect the temporal dependence and frequency characteristics of the time series data well, and is suitable for reconstructing the NFC signal in a noisy environment.

In the last 1D convolutional layer, a convolutional layer with a large kernel size maintains the data scale of the input signal by the output signal.

In addition, each of the first and second discriminators includes an initial 1D convolution layer, a residual block, a flattened layer, and a fully connected layer.

Initially, a 1D convolutional layer with a small kernel size focuses on the local characteristics of the signal and plays an important role in distinguishing the minute difference between the actual signal and the generated fake signal, for example, the frequency characteristics of the communication data.

The residual block provides learning stability while increasing the depth of the network, and the flattening layer flattens the output value to make the output value a binary classification, and then applies a dense layer and a sigmoid activation function to ensure that the prediction value of the discriminator is within an appropriate range.

The fully connected layer introduces a frequency domain loss to minimize distortion occurring in the frequency domain so that the restored signal maintains the same frequency characteristics as the original signal.

In addition, the cycleGAN is trained to generate a fake clean NFC signal x′ that minimizes a difference from the original NFC signal x while minimizing frequency distortion by applying a frequency domain loss function and an adversarial loss function, and is trained to inversely transform the fake clean NFC signal x′ to correspond to the noise NFC signal y by applying a cyclic consistency loss function.

As described above, the cycleGAN is learned using a final loss function calculated as a weighted sum of a frequency domain loss function, an adversarial loss function, and a cyclic consistency loss function as shown in the equation below (Equation 1):

$${L}_{{G}_{t o t a l}} = {L}_{a d v} ( G , {D}_{Y} , X , Y ) + {λ}_{c y c l e} {L}_{c y c l e} ( G , F ) + {λ}_{f r e q} {L}_{f r e q} ( G , F )$$

Here G denotes a first generator, F denotes a second generator, D_{Y} denotes a discriminator of domain Y, X denotes an input of domain X, and Y denotes an input of domain Y. In addition, λ_{cycle} denotes a weight of the cyclic consistency loss function, and λ_{freq} denotes a weight of the frequency domain loss function. In an embodiment of the present disclosure, the weights of the two loss functions are set high at the beginning of learning, and the stability of learning is secured while gradually decreasing as learning progresses.

That is, the weight λ_{cycle} of the cyclic consistency loss function and the weight λ_{freq} of the frequency domain loss function are dynamically adjusted as shown in the equations below (e.g., Equations 2 and 3) to increase the performance of the cycleGAN by focusing on maintaining the frequency and cycle consistency at the beginning of learning, and to stably maintain the signal recovery performance at the end of learning.

In this case, the learning process is repeatedly operated, and in this process, λ_{cycle} and λ_{freq} are updated in a direction of minimizing the final loss function mentioned in Equation 1. In particular, the weight appropriately adjusts how quickly and precisely the model parameter is updated according to the change of the loss function, which is determined for each epoch by subtracting the ratio of completed epochs from the total set epochs as shown in Equations 2 and 3. In this way, Equations 2 and 3 are derived by performing individual processes for λ_{cycle} and λ_{freq} in the same manner. For example, Equation 2 recites:

$${λ}_{c y c l e} ( e p o c h ) = {λ}_{c y c l {e}_{i n i t i a l}} \times ( 1 - \frac{e p o c h}{EPOCHS} )$$

Further, Equation 3 recites:

$${λ}_{f r e q} ( e p o c h ) = {λ}_{f r e {q}_{i n i t i a l}} \times ( 1 - \frac{e p o c h}{EPOCHS} )$$

By adjusting the weight and learning rate during learning in this way, overfitting is prevented in the initial learning stage, and convergence is induced in the second half of learning to ensure better restoration performance.

The data processing unit 130 detects a clock signal by analyzing the temporal characteristics of the clean NFC signal recovered through the restoration unit 120, and generates data used in an application to which NFC communication is applied based on the recovered clean NFC signal and the detected clock signal.

Referring to FIG. 2 in more detail, the clock signal detector 132 detects a clock signal from the clean NFC signal recovered through the restoration unit 120 to provide an accurate timing. The clock signal is generated at a constant period while the NFC signal is transmitted, and when the clock signal is not accurately synchronized, an error may occur in the NFC signal transmission process.

The clock signal detector 132 analyzes the temporal characteristics of the restored clean NFC signal to reconstruct an accurate clock signal and use it for data decoding. The reconfigured clock signal is used for decoding data encoded in a Manchester code. In an embodiment, the Manchester code may encode data through a phase change of the signal, so that data encoding and decoding may be performed correctly only when the clock signal is accurately synchronized. By enabling this, the clock signal detector 132 ensures accurate data transmission even in the recovered signal.

The data generator 134 generates data in a form that may be used in an application to which NFC communication is applied. For example, a smart payment system, an authentication system, a data transmission system, and the like, based on the recovered clean NFC signal and the detected clock signal. This is an important step to ensure that the restored data may be accurately utilized in the actual system, and in particular, it plays an important role in security communication or data transmission between smartphones.

The finally generated data has the same quality as the original data, that is, the original NFC signal, and through this, the user may perform stable communication without signal loss or error that may occur in NFC communication.

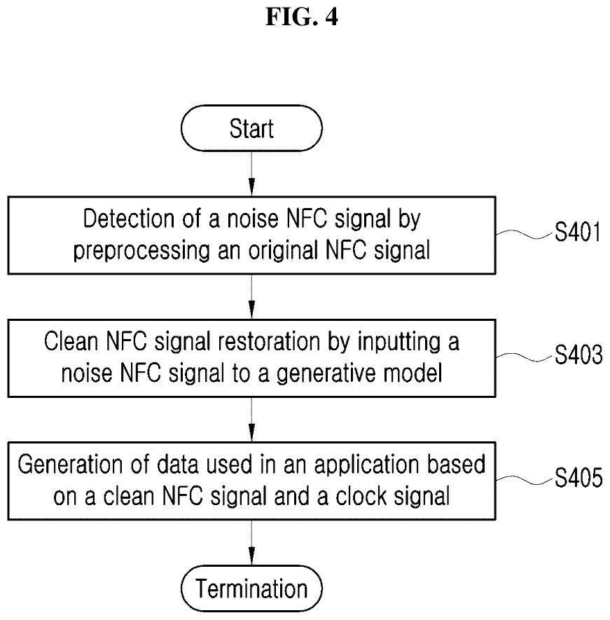

FIG. 4 is a flowchart illustrating an NFC signal recovery operation of an NFC signal recovery device according to an embodiment of the present disclosure. Although one or more steps are described or shown in a particular sequential order, in other embodiments, the operations may be rearranged in a different order, which may including performance of multiple operations in at least partially overlapping time periods. In an embodiment, the method of FIG. 4 is performed by the devices described with reference to FIGS. 1-3.

At step S401, the apparatus for restoring NFC signals receives and preprocesses an original NFC signal transmitted from the NFC signal transmission apparatus, and detects a noise NFC signal whose signal quality is reduced to be less than or equal to the signal quality required for NFC communication in the preprocessing process.

At step S403, the apparatus for restoring NFC signals inputs a noise NFC signal detected in step S401 to a pre-trained generative model, and restores a clean NFC signal of the same signal quality as the original NFC signal by minimizing frequency distortion while maintaining temporal continuity of the noise NFC signal.

At step S405, the apparatus for restoring NFC signals detects a clock signal by analyzing the temporal characteristics of the clean NFC signal recovered in step S403, and generates data used in an application to which the NFC communication is applied based on the recovered clean NFC signal and the detected clock signal.

The NFC signal restoration method of the present disclosure may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

What is claimed is:

1. An apparatus for restoring Near Field Communication (NFC) signals comprising:
preprocessing circuitry configured to receive and preprocess an original NFC signal transmitted from an NFC signal transmission device, and detect a noise NFC signal whose signal quality is lowered below a signal quality required for NFC communication in a preprocessing process;
restoration circuitry configured to input the noise NFC signal to a pre-trained generative model, and restore the noise NFC signal to a clean NFC signal of a same signal quality as the original NFC signal by minimizing frequency distortion while maintaining temporal continuity of the noise NFC signal; and
data processing circuitry configured to detect a clock signal by analyzing a temporal characteristic of the clean NFC signal, and generate data used in an application to which the NFC communication is applied based on the clean NFC signal and the detected clock signal.

2. The NFC signal restoration apparatus of claim 1, wherein the preprocessing circuitry further comprises an Analog to Digital (A/D) converter and a decoder, and the noise NFC signal is a signal that is distorted or lost in a process in which the A/D converter converts an analog signal into a digital signal or the noise NFC signal is a signal that the decoder fails to decode.

3. The NFC signal restoration apparatus of claim 1, wherein:
the pre-trained generative model is provided through a process of inputting the original NFC signal to a first generator to artificially degrade the signal quality of the original NFC signal to generate a fake noise NFC signal,
training a first discriminator to compare and distinguish the noise NFC signal and the fake noise NFC signal,
inputting the noise NFC signal to a second generator to generate a fake clean NFC signal by minimizing frequency distortion while maintaining the temporal continuity of the noise NFC signal, and
training a second discriminator to compare and distinguish the fake clean NFC signal and the original NFC signal.

4. The NFC signal restoration apparatus of claim 3, wherein the pre-trained generative model is trained to generate the fake clean NFC signal that minimizes a difference from the original NFC signal while minimizing frequency distortion by applying a frequency domain loss function and an adversarial loss function, and is trained to inversely transform the fake clean NFC signal by applying a cyclic consistency loss function to be identical to the noise NFC signal.

5. The NFC signal restoration apparatus of claim 4, wherein the pre-trained generative model is trained using a final loss function calculated as a weighted sum of the adversarial loss function, the cyclic consistency loss function, and the frequency domain loss function.

6. The NFC signal restoration apparatus of claim 1, wherein the data processing circuitry further comprises:
a clock signal detector configured to detect the clock signal from the clean NFC signal, wherein the clock signal is generated at a constant period while the original NFC signal is transmitted.

7. The NFC signal restoration apparatus of claim 6, wherein the clock signal detector is further configured to reconstruct an accurate clock signal and utilize the accurate clock signal for data decoding based on analyzing the temporal characteristics of the clean NFC signal.

8. The NFC signal restoration apparatus of claim 1, wherein the data processing circuitry further comprises:
a data generator configured to generate data in a form that is used in an application to which the NFC communication is applied to.

9. A method for restoring a Near Field Communication (NFC) signal, the method comprising:
receiving, by preprocessing circuitry, an original NFC signal transmitted from an NFC signal transmission device to preprocess the received original NFC signal, and detecting a noise NFC signal whose signal quality is reduced to a signal quality required for the NFC communication in a preprocessing process;
inputting, by restoration circuitry, the noise NFC signal to a pre-trained generative model, and restoring the noise NFC signal to a clean NFC signal of a same signal quality as the original NFC signal by minimizing frequency distortion while maintaining temporal continuity of the noise NFC signal; and
detecting, by data processing circuitry, a clock signal by analyzing temporal characteristics of the clean NFC signal, and generating data used in an application to which the NFC communication is applied based on the clean NFC signal and the detected clock signal.

10. The method of claim 9, wherein the preprocessing circuitry further comprises an Analog to Digital (A/D) converter and a decoder, and the noise NFC signal is a signal that is distorted or lost in a process in which the A/D converter converts an analog signal into a digital signal or the noise NFC signal is a signal that the decoder fails to decode.

11. The method of claim 9, wherein:
The pre-trained generative model is provided through a process of inputting the original NFC signal to a first generator to artificially degrade the signal quality of the original NFC signal to generate a fake noise NFC signal,
training a first discriminator to compare and distinguish the noise NFC signal and the fake noise NFC signal,
inputting the noise NFC signal to a second generator to generate a fake clean NFC signal by minimizing frequency distortion while maintaining the temporal continuity of the noise NFC signal, and
training a second discriminator to compare and distinguish the fake clean NFC signal and the original NFC signal.

12. The method of claim 11, wherein the pre-trained generative model is trained to generate the fake clean NFC signal that minimizes a difference from the original NFC signal while minimizing frequency distortion by applying a frequency domain loss function and an adversarial loss function, and is trained to inversely transform the fake clean NFC signal by applying a cyclic consistency loss function to be identical to the noise NFC signal.

13. The method of claim 12, wherein the pre-trained generative model is trained using a final loss function calculated as a weighted sum of the adversarial loss function, the cyclic consistency loss function, and the frequency domain loss function.

14. The method of claim 9, further comprising:
detect, at a clock signal detector, the clock signal from the clean NFC signal, wherein the clock signal is generated at a constant period while the original NFC signal is transmitted.

15. The method of claim 14, further comprising:
reconstructing, at the clock signal detector, an accurate clock signal and utilizing the accurate clock signal for data decoding based on analyzing the temporal characteristics of the clean NFC signal.

16. The method of claim 9, further comprising:
generating, at a data generator, data in a form that is used in an application to which the NFC communication is applied to.
